(19) United States
(12) Patent Application Publication
(10) Pub. No.: US 2008/0145182 A1
(43) Pub. Date: Jun. 19, 2008

(54) Fastening element

(75) Inventor: Peter Gstach, Schaan (LI)

Correspondence Address: ABELMAN, FRAYNE & SCHWAB, 666 THIRD AVENUE, 10TH FLOOR, NEW YORK, NY, 10017, US

(73) Assignee: Hilti Aktiengesellscahft

(21) Appl. No.: 11/999,953

(22) Filed: Dec. 7, 2007

(30) Foreign Application Priority Data
Dec. 19, 2006 (DE) 10 2006 000 539.2

(51) Int. Cl. F16B 23/00

(52) U.S. Cl. 411/403

(57) ABSTRACT

A fastening element for mineral constructional components includes a thread-tapping thread (21, 41) extending at least partially along the stem (12, 32) of the fastening element and having side flanks (23, 24, 45, 47), with the side flanks (23, 24, 45, 47) form together an angle (W, V) of from 10° to 35°, and with a ratio of an outer diameter (A) of the thread (21, 41) to a root diameter (K) of the stem (12, 32) amounting to from 1.1 to 1.4, and a ratio of the outer diameter (A) of the thread (21, 41) to a pitch (P) of the thread (21, 41) amounting to from 1.4 to 1.7.

### BACKGROUND OF THE INVENTION

1. Field of the Invention

The present invention relates to a fastening element for mineral constructional components that includes a stem having rotation application means for a setting tool and provided at one of its ends, and a thread-tapping thread extending at least partially along the stem and having side flanks.

2. Description of the Prior Art

Fastening elements of the type described above are screwed in boreholes, which were preliminary formed in a mineral constructional component, e.g., in concrete or breakwork, with the self-tapping thread cutting into a borehole wall, and with the fastening element being anchored in the borehole by the produced undercuts for transmitting a load to the borehole wall. The fastening element is formed, e.g., as a screw with a hexagon or square head provided at one end of the screw stem and serving as rotation application means. Alternatively, a fastening element can be formed, e.g., as a sleeve having an inner thread and used as internal rotation application means, and having a thread-tapping thread on its outer side.

European Patent EP 0697 071 B 1 discloses a fastening element for a mineral constructional component and formed as a thread-tapping screw having a stem with rotation application means provided at one of its end and with a thread-tapping thread extending regionwise along the stem. The flank angle of the thread amounts to from 35° to 50°, and ratios of the outer diameter of the thread to the root diameter of the stem and to the thread pitch amount, respectively, from 1.25 to 1.5 and from 1.5 to 1.6.

For an optimal carrying capability of such fastening elements, the size and the quality of the undercut surfaces, which are produced in the constructional component by the self-tapping thread, are of a paramount importance. The drawback of the fastening element of the above-discussed European Patent consists in that with the ratios discussed above, the constructional component can be damaged during tapping of the thread, which leads to a noticeable reduction of the carrying capability of the set screw.

Accordingly, an object of the invention is to provide a thread-tapping fastening element for mineral constructional components and having advantageous load-bearing and setting characteristics.

### SUMMARY OF THE INVENTION

This and other objects of the present invention, which will become apparent hereinafter, are achieved by providing a fastening element of the type discussed above and in which the side flanks form together an angle from 10° to 35°, a ratio of an outer diameter of the thread to a root diameter of the stem amounts to from 1.1 to 1.4, and a ratio of the outer diameter of the thread to a pitch of the thread amounts to from 1.4 to 1.7.

With smaller thread flanks and with above-mentioned ratios, the thread is cut more easily upon setting of the fastening element in the constructional component, and the produced undercut surfaces in the constructional component correspond essentially to the negative shape of the thread-tapping thread. At the same undercut depth, a smaller undercut volume is formed in the constructional component, which results in a noticeably smaller damage of the mineral constructional component than is the case with fastening elements known up to the present.

Because a smaller undercut volume is produced in the constructional component, the screw-in resistance to the inventive fastening element is reduced. In addition, less drilling dust is produced upon setting of the fastening element according to the present invention. Altogether, the fastening element according to the present invention not only has an improved load-bearing capability but also has noticeably improved setting characteristics.

Advantageously, a thread width at its outer circumference is smaller than 0.5 mm. It is particular advantageous when this width is less than 0.3 mm. This width, in particular in combination with the flank angle of the thread discussed above, permits to form, in the constructional component, advantageously, a negative form corresponding to the thread. The constructional component is noticeably less damaged than when the thread has a sturdy profile.

Advantageously, the thread has spaced from each other and opening radially outwardly recesses. The recesses are generally in form of, e.g., rectangular or triangular indentations which form so-called cutting teeth for the thread and which contribute to tapping of a thread in a constructional component.

Advantageously, the stem has at its end opposite the rotation application means, an insertion section and the thread extends from a region of the opposite end, and the recesses are provided in the region of the opposite end. Thus, the recesses advantageously facilitate tapping at the beginning of the tapping process, with the regions of the thread without recesses penetrating in the pre-tapped counter-thread.

Advantageously, the flanks of the thread are divergent and each has a least two flank sections. The radially outer flank sections of the flanks form an angle from 10° to 35°, and at least the flank sections of the flanks adjacent to the thread root form a further angle that is greater than the angle formed by the radially outer flank sections. Thus, the thread has two flank angles as it diverges toward the thread root with two different angle values, with the angle of the outer flank sections of the thread occupying an advantageous region. The height of the outer section of the thread, which is formed by the radially outer flank sections, is advantageously so selected that it is this thread section that forms the main portion of the undercut in the constructional component. The thread section, which adjoins the outer thread section and which has a larger angle, advantageously compresses the rim of the tapped counter-thread and smoothes the eventual material outbreaks. Advantageously, the thread has only two sections, with the inner thread section, which is located between the outer thread section and the thread root, having a flank angle from 50° to 150°.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side view of a thread-tapping screw according to the present invention;

FIG. 2 a side view of the front section of the screw shown in FIG. 1 at an increased, in comparison with FIG. 1, scale;

FIG. 3 a cross-sectional view of the thread flanks; and

FIG. 4 a cross-sectional view of the thread flanks of another embodiment of the thread of a screw according to the present invention.

### DETAILED DESCRIPTION OF THE PREFERRED EMBODIMENTS

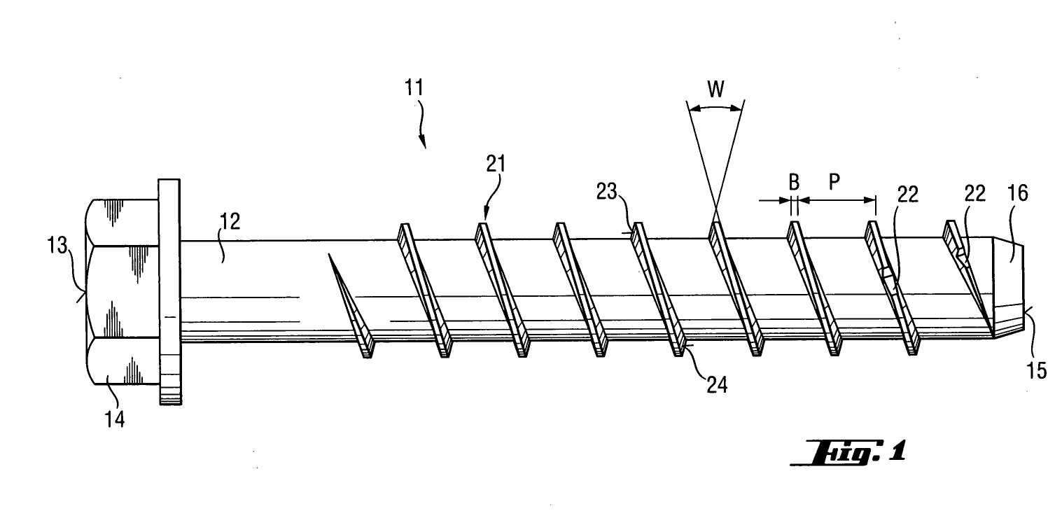

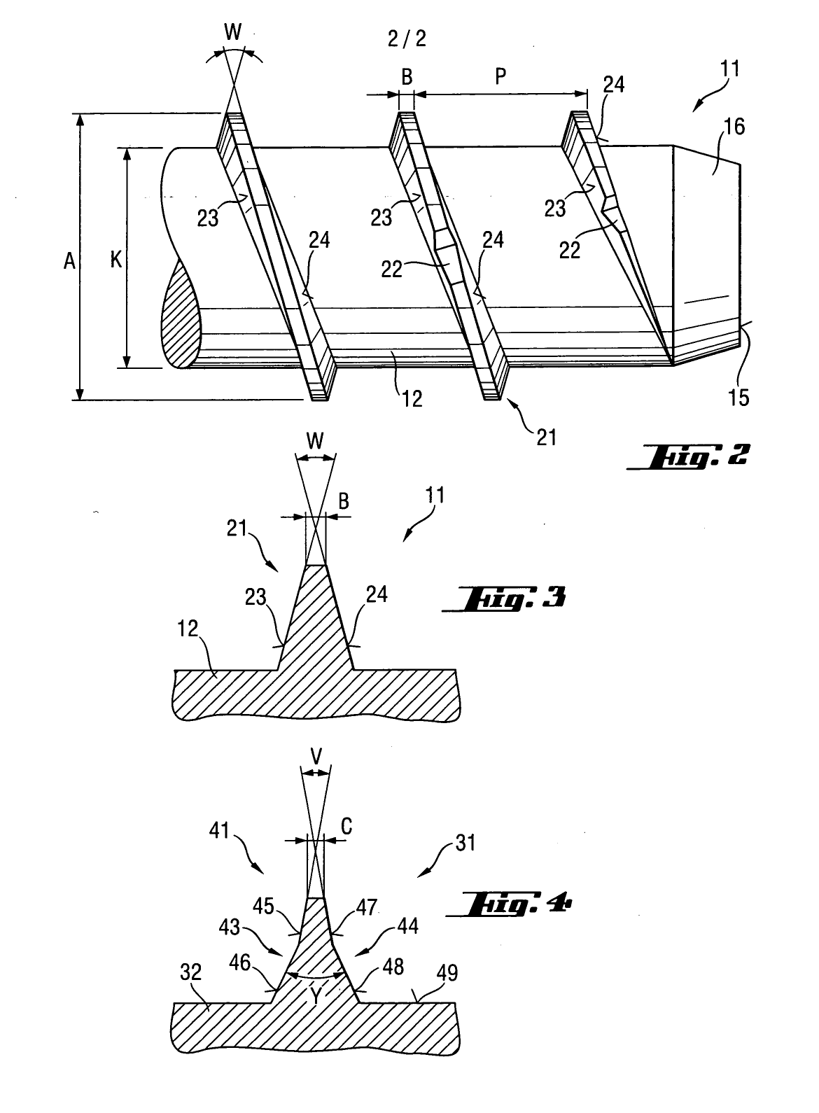

A fastening element 11 according to the present invention for mineral constructional components, which is shown in FIG. 1-3, is formed as a self-tapping screw with a cylindrical stem 12. At one of its ends, the first end 13, the stem 12 has a hexagon head that serves as rotation application means 14 for a setting tool, not shown. At its second end 15, the stem has an insertion section 16. Starting from a region of the second end 15, a thread-tapping thread 21 extends regionwise along the stem 12. In the region of the second end 15, there are provided spaced from each other, triangular recesses 22 which open radially outwardly.

An angle W of flanks 23 and 24 of the thread 21 amounts to 30°, a ratio of an outer diameter A of the thread 21 to a root diameter K of the stem 12 amounts to 1.3, and a ratio of the outer diameter A of the thread to a pitch P of the thread 21 amounts to 1.55. Width B of the thread 21 at its circumference amounts to 0.30 mm.

FIG. 4 shows a cross-sectional view of a thread-tapping thread 41 of another embodiment of a fastening element according to the present invention and which is likewise formed as a thread-tapping screw. The flanks 43 and 44 of the thread 41 are formed as divergent flanks and have each two flank sections 45, 46 and 47, 48, respectively. The radially outer flank sections 45, 47 of the flanks 43, 44 form together an angle V of 20°, and the flank sections 46, 48 adjacent to the thread root 49 enclosed together an angle Y of 60°. The thread 41 has an increasing divergence toward the thread root 49 at the stem 32 with different angle values. The width C of the threat 41 at its outer circumference amount to 0.25 mm. Otherwise, the fastening element 31 has the same ratios of the outer diameter of the thread 41 to its pitch and of its outer diameter to the root diameter of the stem 32 as the fastening element 11.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A fastening element for mineral constructional components, comprising a stem (12, 32) having rotation application means (14) for a setting tool and provided at one of its ends (13); and a thread-tapping thread (21, 41) extending at least partially along the stem (12, 32) and having side flanks (23, 24, 45, 47), wherein the side flanks (23, 24, 45, 47) form together an angle (W, V) of from 10° to 35°, a ratio of an outer diameter (A) of the thread (21, 41) to a root diameter (K) of the stem (12, 32) amounts to from 1.1 to 1.4, and a ratio of the outer diameter (A) of the thread (21, 41) to a pitch (P) of the thread (21, 41) amounts to from 1.4 to 1.7.

2. A fastening element according to claim 1, wherein a width (B, C) of the thread (21, 41) at an outer circumference thereof is smaller than 0.5 mm.

3. A fastening element according to claim 1, wherein the thread (21) has spaced from each other, recesses (22) which open radially outwardly.

4. A fastening element according to claim 3, wherein the stem (12) has, at another end thereof (15) opposite the one end (13), and insertion section (16) and wherein the thread (21) extends from a region of another end (15) and the recesses (22) are provided in the region of another end (15).

5. A fastening element according to claim 1, wherein the flanks (43, 44) of the thread (41) are divergent and each has at least two flank sections (45, 46 and 47) and wherein the radially outer flank sections (45, 47) of the flanks (43, 44) form an angle (V) from 10° to 35°, and at least the flank sections (46, 48) of the flanks (43, 44) adjacent to the thread root (49) form a further angle (Y) that is greater than the angle (V) formed by the radially outer flank sections (45, 47).
